(19) United States
(12) Patent Application Publication
(10) Pub. No.: US 2003/0056577 A1
(43) Pub. Date: Mar. 27, 2003

(54) Sensor cell for measuring the concentration of a component in a two-component liquid mixture, method, apparatus and etching system

(76) Inventors: Stefan Ottow, Dresden (DE); Ronald Hoyer, Dresden (DE); Hans Ulrich Stiehl, Dresden (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/252,994

(22) Filed: Sep. 23, 2002

(30) Foreign Application Priority Data
Sep. 21, 2001 (EP) 01122756.8

(51) Int. Cl. G01N 25/00

(52) U.S. Cl. 73/61.46; 73/61.44

(57) ABSTRACT

A sensor cell measures a component of a two-component liquid mixture. A control apparatus controls a concentration of the component in the mixture. The control apparatus can be applied to an etching system for etching a silicon nitride layer. The sensor cell contains a sample inlet for feeding the mixture, a sample drain, a vapor outlet, an apparatus for setting a temperature of the liquid mixture to a temperature below the boiling point, a heating element for elevating the temperature of the liquid mixture to a temperature above the boiling point, and a device for calculating the concentration of the component based on a temperature of the liquid versus temperature of the heating element characteristics. The concentration of the component can be assessed by determining a point at which a slope of the temperature of the liquid versus temperature of the heating element characteristics is changed.

### BACKGROUND OF THE INVENTION

### FIELD OF THE INVENTION

The present invention refers to a sensor cell for measuring as well as an apparatus for controlling a concentration of a component in a two-component liquid mixture, and, in particular, to an etching system for etching a silicon nitride layer. The invention further refers to a method for measuring the concentration of a component in a two component liquid mixture.

More specifically, the present invention relates to a measurement system for the inline determination of water content in an aqueous solution based on a boiling point thereof. The measurement system can advantageously be applied for the in-situ control of the water content in so-called HOT PHOS (hot phosphoric acid) baths.

Usually, in the manufacture of semiconductor integrated circuits, HOT PHOS baths are used for wet-etching of silicon nitride layers. Silicon nitride is generally used as a masking layer or as an insulator layer. When it becomes necessary to remove or to pattern the silicon nitride layer, normally, wet etching with hot phosphoric acid at 160° C. with approximately 85 wt-% H₃PO₄ is used.

$${Si}_{3} {N}_{4} + 6 {H}_{2} O {\to }^{ {H}_{3} {PO}_{4 }} 3 {SiO}_{2} + 4 {NH}_{3}$$

Since the etching rate of silicon nitride is more than ten times higher than the etching rate of silicon dioxide, silicon nitride is selectively etched. However, two important factors influence the etching rate of both silicon nitride and silicon dioxide: (i) the bath temperature which is normally a constant temperature at around 160° C. and (ii) the water content of the bath, which strongly influences the oxide etching rate and, therefore, the etching selectivity.

Since the etching process is performed at a temperature above the boiling point of the etching solution, water is constantly evaporated by the following reaction:

4H₃PO₄⇄2H₄P₂O₇+2H₂O

Accordingly, the water content of the bath usually varies. This is also caused by the water evaporation during lid opening and the chemical etching reaction. So far, a constant amount of water is continuously spiked during the process, but this procedure is not well controlled and the amount of spiked water is often determined empirically.

In particular, this procedure is not well controlled and often determined empirically, especially during load/unload sequences in the HOT PHOS tank.

U.S. Pat. No. 5,938,885 discloses a hydrometer cell that can be connected with an etching chamber, for assessing the phosphoric acid content of an aqueous phosphoric acid based on the specific gravity of the aqueous phosphoric acid. Based on this measurement result, the water content can be raised by adding water.

Moreover, U.S. Pat. No. 4,980,017 discloses a method for recirculating a high-temperature etching solution, wherein a portion of the etching solution is continuously removed from an etching bath, and an amount of water is added to the removed portion. The amount of water added is determined on the basis of the temperature difference between a preset boiling temperature and the actual temperature of the removed portion of the etching solution.

### SUMMARY OF THE INVENTION

It is accordingly an object of the invention to provide a sensor cell for measuring the concentration of a component in a two-component liquid mixture, a method, an apparatus and an etching system which overcome the above-mentioned disadvantages of the prior art devices and methods of this general type.

With the foregoing and other objects in view there is provided, in accordance with the invention, a sensor cell for measuring a concentration of a component in a two-component liquid mixture. The sensor cell contains a sample inlet for feeding the two-component liquid mixture into the sensor cell, a sample drain for draining the two-component liquid mixture from the sensor cell, a vapor outlet for exhausting an evaporated component from the two-component liquid mixture, and an apparatus for setting a temperature of the two-component liquid mixture to below a boiling point of the two-component liquid mixture. A heating element is providing for elevating the temperature of the two-component liquid mixture to above the boiling point of the two-component liquid mixture. A device is provided for calculating a concentration of the component based on an actual temperature of the two-component liquid mixture versus heating element temperature characteristics.

Moreover, the object of the present invention is achieved by an apparatus for controlling the concentration of a component in a two-component liquid mixture containing the sensor cell as defined above. The apparatus further has a tank for storing the component having the lower boiling point, a pump for adding an amount of the component having the lower boiling point and a control system for setting the amount of the component added to the liquid mixture based on the result supplied by the sensor cell.

In particular, the present invention provides an etching system for etching a silicon nitride layer deposited on a substrate, containing a process tank filled with aqueous ortho-phosphoric acid. The process tank has an outlet for draining part of the aqueous ortho-phosphoric acid and an inlet for feeding aqueous ortho-phosphoric acid. The substrate is placed into the process tank and an apparatus for controlling the concentration of a component in a two-component liquid mixture as defined above, wherein the sensor cell is connected with the process tank inlet and the process tank outlet.

Accordingly, the present invention provides a sensor cell which can in-situ monitor the concentration of one component of a two-component liquid mixture. Based on this concentration, an amount of the component having the lower boiling point can be added to the liquid mixture from a tank for storing the component.

Thus, the present invention provides the now described advantages. The concentration of a component in a two-component liquid mixture can exactly and in-situ be measured. Thereby, it becomes possible to in-situ control the concentration of the component by adding an amount of the component having the lower boiling point based on the measurement result. As a consequence, when the present invention is applied to a HOT PHOS bath for etching a silicon nitride layer, the etch rate of the silicon nitride in comparison to the silicon dioxide can advantageously be stabilized whereby a high selectivity is given and, consequently, the process becomes much improved. As a further consequence the life cycle of the bath will be extended. The sensor cell of the present invention and the apparatus for controlling the concentration of a component have a comparatively simple instrumentation. As a consequence, they can be easily applied to existing apparatus without any need for a major change of the hardware setup thereof. The measurement as well as the in-situ control of the concentration can be automatically performed.

In accordance with an added feature of the invention, the device for calculating the concentration of the component is adapted to determine a point at which a slope of the actual temperature of the two-component liquid mixture versus the heating element temperature characteristics is changed, and the heating element temperature characteristics is a time based characteristic.

In accordance with an additional feature of the invention, the two-component liquid mixture is held at a temperature near the boiling point, and the apparatus for setting the temperature of the two-component liquid mixture is a cooling element which is adapted to cool the two-component liquid mixture to a predetermined temperature below the boiling point of the two-component liquid mixture.

In accordance with another feature of the invention, the heating element is adapted to elevate the temperature of the two-component liquid mixture to a predetermined temperature above the boiling point of the two-component liquid mixture. The predetermined temperature is 15 K and the two-component liquid mixture is an aqueous ortho-phosphoric acid.

With the foregoing and other objects in view there is provided, in accordance with the invention, a method for measuring a concentration of a component in a two-component liquid mixture. The method includes feeding the two-component liquid mixture into a sensor cell, draining the two-component liquid mixture from the sensor cell, exhausting an evaporated component from the two-component liquid mixture, setting a temperature of the two-component liquid mixture to below a boiling point of the two-component liquid mixture, elevating the temperature of the two-component liquid mixture to above the boiling point of the two-component liquid mixture, and calculating a concentration of the component based on an actual temperature of the two-component liquid mixture versus heating element temperature characteristics.

In accordance with an added mode of the invention, there is the step of determining a point at which a slope of the actual temperature of the two-component liquid mixture versus the heating element temperature characteristics changes. The heating element temperature characteristics is a time characteristic.

In accordance with another mode of the invention, there are the steps of holding the two-component liquid mixture at a temperature near the boiling point, and cooling the two-component liquid mixture to a predetermined temperature below the boiling point of the two-component liquid mixture.

Other features which are considered as characteristic for the invention are set forth in the appended claims.

Although the invention is illustrated and described herein as embodied in a sensor cell for measuring the concentration of a component in a two-component liquid mixture, a method, an apparatus and an etching system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a setup of an etching system according to the invention;

FIG. 2 is an illustration of the setup of a sensor cell; and

FIG. 3 is a graph illustrating temperature versus concentration (time) characteristics of a HOT PHOS system.

### DESCRIPTION OF THE PREFERRED EMBODIMENTS

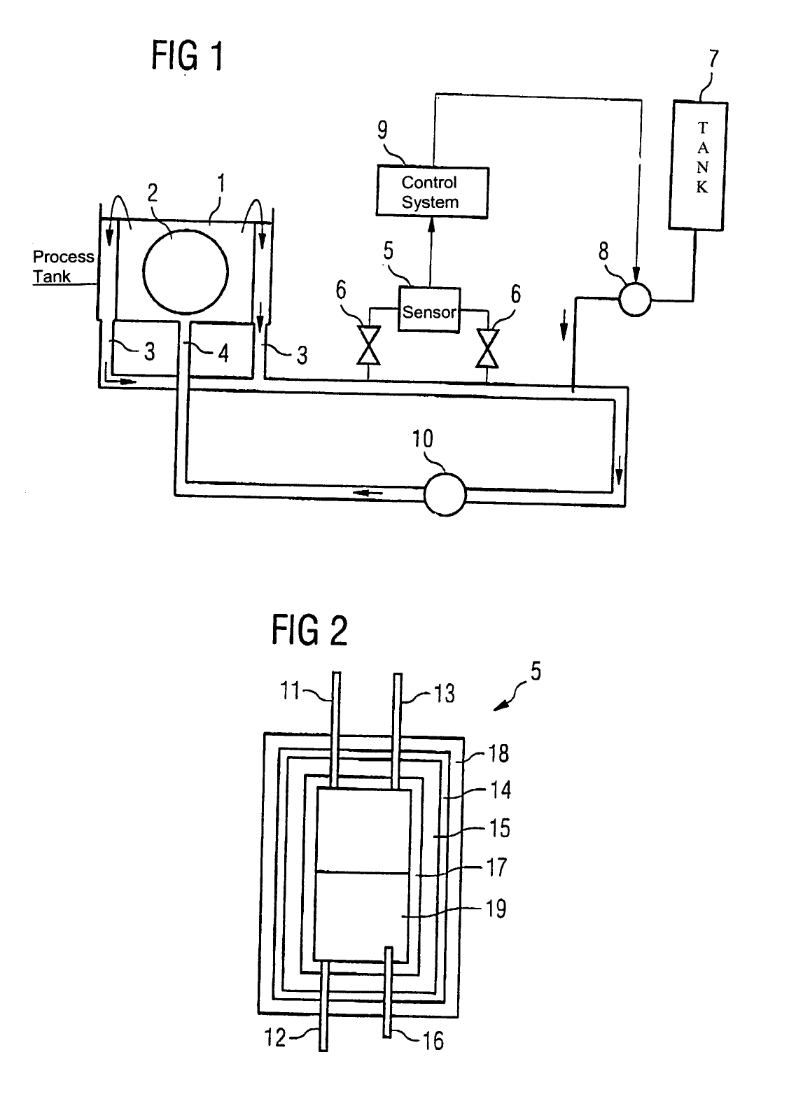

Referring now to the figures of the drawing in detail and first, particularly, to FIG. 1 thereof, there is shown a process tank 1 which is filled with hot aqueous ortho-phosphoric acid (H₃PO₄), and a semiconductor wafer 2 which is placed in the process tank 1, the semiconductor wafer 2 having a silicon nitride layer thereon which is to be etched. In one practical embodiment, the volume of the aqueous ortho-phosphoric acid in the process tank amounts to approximately 80 liter. The hot aqueous ortho-phosphoric acid is held at a temperature of approximately 160° C. by a non-illustrated heating apparatus.

The process tank 1 has an outlet 3 for permanent recirculation of at least part of the aqueous ortho-phosphoric acid and an inlet 4 for permanently feeding the aqueous ortho-phosphoric acid. The outlet 3 and the inlet 4 form part of a recirculation line in which the ortho-phosphoric acid is circulated by a pump 10. Water from a water tank 7 is constantly added into the ortho-phosphoric acid. In the practical embodiment, the flow rate is in the range of approximately 70 milliliters/minute. A part of the ortho-phosphoric acid circuit is by-passed by a sensor cell 5 for measuring a concentration of the ortho-phosphoric acid. A measurement result of the sensor cell 5 is forwarded to a control system 9 which in turn controls an amount of water supplied from the water tank 7 by a pump 8. Inlet and outlet valves 6 for regulating the flow of the ortho-phosphoric acid into and out from the sensor cell 5 are also provided.

The sensor cell 5 for measuring the water concentration in the aqueous ortho-phosphoric acid has a setup as shown in FIG. 2. There are provided a sample inlet 11 for feeding a sample 19 of the ortho-phosphoric acid to the sensor cell 5, and a sample drain 12 for draining the ortho-phosphoric acid from the sensor cell 5. A typical sample volume amounts to approximately 1 to 2 ml (milliliter). A vapor outlet 13 for exhausting evaporated water is also provided. A cooling apparatus 14 is provided which lowers the temperature of the hot phosphoric acid, to a value well below, advantageously 15 K below the boiling point of the liquid. A heating element 15 is also provided for elevating the temperature to a temperature well above, advantageously 15 K above the boiling point of the sample. A temperature probe for measuring the actual temperature of the sample is denoted by reference numeral 16. A thermal short circuit 17 for providing a uniform temperature within the sensor cell, and an insulation 18 for thermally insulating the sample from the exterior, are provided.

The measurement of the water concentration of the hot aqueous ortho-phosphoric acid is performed as follows. First, a calibration with a solution having a known water concentration is performed. The processing of the result of the calibration measurement will be explained later. Thereafter, the sensor cell 5 is rinsed with a sample liquid with a volume of approximately 5 times a cell volume. Then, the sample is cooled down by the cooling apparatus 14 to approximately 15 K below the boiling point of the sample. Thereafter, the sample is heated by the heating element 15 to approximately 15 K above the boiling point of the sample. During the heating sequence the temperature difference ΔT of the sample against the heating element is assessed. It is plotted in a diagram over time or concentration, respectively. The heating element 15 is heated up linearly. The temperature of the heating element 15 is the reference system for the temperature.

Assuming a constant heating rate of the heating element 15, a sample temperature in dependence on the time can be plotted. The sample temperature can easily be assessed by measuring a temperature difference between the sample and the heating element that is taken as a reference. In this case, the absolute sample temperature as a reference point is only needed once for quantification.

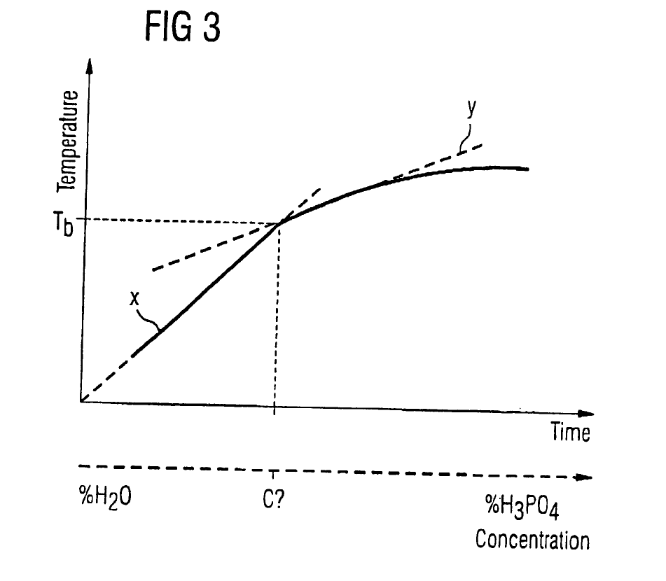

An exemplary diagram showing the sample temperature versus time characteristics of a hot aqueous ortho-phosphoric acid is shown in FIG. 3. For assessing the concentration of the sample, the point at which the slope of the characteristics changes is determined. As can be gathered from FIG. 3, the sample temperature versus time characteristics assumes the form of a straight line in a lower portion thereof, whereas it assumes a different form in the higher portion thereof.

This can be explained as follows. In a system, if a pure, not decomposable substance is heated, the temperature will not exceed the boiling point thereof. If a liquid mixture is heated at a constant heating rate, the temperature thereof will first increase linearly with time as indicated by the straight line x. As soon as a boiling point T_{b} of the liquid mixture is reached, the boiling point of the two-component mixture is represented by the line y because one component is constantly evaporated and therefore the concentration of the liquid phase is constantly changed. Differently stated, the decrease of the water content of the aqueous hot phosphoric acid results in a higher energy amount for further water evaporation.

Accordingly, the point at which the slope of the sample temperature versus time characteristics is changing indicates on the temperature axis the boiling point of the liquid mixture having the water concentration which is to be determined. If the time axis is appropriately calibrated, the point at which the slope of the sample temperature versus time changes indicates on the time axis the water concentration of the sample.

The point at which the slope of the sample temperature versus time characteristics is changing can for example be assessed by determining the point of intersection between the straight line x and a tangent to the line y. The exact point at which the tangent touches the line y can be best determined empirically by using several water-phosphoric acid mixtures having different but known concentrations. In particular, the “best-matching” tangent to line y, that is the tangent having the highest number of measuring points in common or nearly in common with line y can be chosen.

Next, from the calibration measurement that was conducted under the same heating conditions before the beginning of the concentration measurement of the sample, this point of intersection indicating a specific time on the time axis, is set into relation with a specific concentration of the phosphoric acid.

The measurement time typically is about 5 to 10 minutes, in dependence from the required accuracy of the measurement and the used temperature range. In particular, the velocity for heating the sample is limited because a dynamic equilibrium in the sample is necessary for the temperature measurement.

After the measurement has been finished, the sample is drained from the sensor cell by opening the outlet valve so that the used sample will be returned to the main fluid loop. The control system 9 controls the pump 8 so that the water flow into the liquid circuit is set in dependence on the measured water concentration.

Thereafter, a new measurement of the water content can be performed. Since typical time constants for reaching an equilibrium within the liquid mixture amount to approximately 30 minutes, the time interval between measurements should be of the same order.

Accordingly, the water concentration of the HOT PHOS bath can be in-situ measured and, as a consequence, the water concentration can be easily and inline controlled by setting the amount of water added on the basis of the measurement result. Hence, it is possible to maintain constant the water content of the aqueous phosphoric acid whereby the etching rate of silicon nitride and silicon dioxide can be maintained constant.

In particular, the whole measurement and control cycle of the water content can be fully automated, whereby the control of the etching process can be further simplified.

Although the present invention has been described with respect to an aqueous phosphoric acid, it is obvious that it can also be applied to any other two component liquid mixture.

We claim:

1. A sensor cell for measuring a concentration of a component in a two-component liquid mixture, comprising:
a sample inlet for feeding the two-component liquid mixture into the sensor cell;
a sample drain for draining the two-component liquid mixture from the sensor cell;
a vapor outlet for exhausting an evaporated component from the two-component liquid mixture;
an apparatus for setting a temperature of the two-component liquid mixture to below a boiling point of the two-component liquid mixture;
a heating element for elevating the temperature of the two-component liquid mixture to above the boiling point of the two-component liquid mixture; and
a device for calculating a concentration of the component based on an actual temperature of the two-component liquid mixture versus heating element temperature characteristics.

2. The sensor cell according to claim 1, wherein said device for calculating the concentration of the component is adapted to determine a point at which a slope of the actual temperature of the two-component liquid mixture versus the heating element temperature characteristics is changed, and the heating element temperature characteristics is a time based characteristic.

3. The sensor cell according to claim 1, wherein the two-component liquid mixture is held at a temperature near the boiling point, and said apparatus for setting the temperature of said two-component liquid mixture is a cooling element which is adapted to cool the two-component liquid mixture to a predetermined temperature below the boiling point of the two-component liquid mixture.

4. The sensor cell according to claim 1, wherein said heating element is adapted to elevate the temperature of the two-component liquid mixture to a predetermined temperature above the boiling point of the two-component liquid mixture.

5. The sensor cell according to claim 3, wherein the predetermined temperature is 15 K.

6. The sensor cell according to claim 1, wherein the two-component liquid mixture is an aqueous ortho-phosphoric acid.

7. An apparatus for controlling a concentration of a component in a two-component liquid mixture, comprising:
a sensor cell containing:
a sample inlet for feeding the two-component liquid mixture into the sensor cell;
a sample drain for draining the two-component liquid mixture from the sensor cell;
a vapor outlet for exhausting an evaporated component from the two-component liquid mixture;
an apparatus for setting a temperature of the two-component liquid mixture to below a boiling point of the two-component liquid mixture;
a heating element for elevating the temperature of the two-component liquid mixture to above the boiling point of the two-component liquid mixture; and
a device for calculating a concentration of the component based on an actual temperature of the two-component liquid mixture versus heating element temperature characteristics;
a tank for storing the component being a first component of the two-component liquid mixture having a lower boiling point than a second component of the two-component liquid mixture;
a pump for adding an amount of the first component having the lower boiling point; and
a control system for setting an amount of the first component added to the two-component liquid mixture based on a result supplied by said sensor cell, said control system connected to said sensor cell and connected to and controlling said pump.

8. An etching system for etching a silicon nitride layer deposited on a substrate, comprising:
a process tank filled with an aqueous ortho-phosphoric acid, said process tank having an outlet for draining part of the aqueous ortho-phosphoric acid and an inlet for receiving the aqueous ortho-phosphoric acid, the substrate being placed into said process tank; and
an apparatus for controlling a concentration of a component in a two-component liquid mixture, said apparatus containing:
a sensor cell fluidically communicating with said inlet and said outlet of said process tank, said sensor cell containing:
a sample inlet for receiving the two-component liquid mixture into the sensor cell;
a sample drain for draining the two-component liquid mixture from the sensor cell;
a vapor outlet for exhausting an evaporated component from the two-component liquid mixture;
an apparatus for setting a temperature of the two-component liquid mixture to below a boiling point of the two-component liquid mixture;
a heating element for elevating the temperature of the two-component liquid mixture to above the boiling point of the two-component liquid mixture; and
a device for calculating a concentration of the component based on an actual temperature of the two-component liquid mixture versus heating element temperature characteristics;
a tank for storing the component being a first component of the two-component liquid mixture having a lower boiling point than a second component of the two-component liquid mixture;
a pump for adding a further amount of the component having the lower boiling point to the two-component liquid mixture, said pump fluidically communicating with said tank and said process tank; and
a control system for setting an amount of the first component added to the two-component liquid mixture based on a result supplied by said sensor cell, said control system connected to said sensor cell and connected to and controlling said pump.

9. A method for measuring a concentration of a component in a two-component liquid mixture, which comprises the steps of:
feeding the two-component liquid mixture into a sensor cell;
draining the two-component liquid mixture from the sensor cell;
exhausting an evaporated component from the two-component liquid mixture;
setting a temperature of the two-component liquid mixture to below a boiling point of the two-component liquid mixture;
elevating the temperature of the two-component liquid mixture to above the boiling point of the two-component liquid mixture; and
calculating a concentration of the component based on an actual temperature of the two-component liquid mixture versus heating element temperature characteristics.

10. The method according to claim 9, which comprises determining a point at which a slope of the actual temperature of the two-component liquid mixture versus the heating element temperature characteristics changes, the heating element temperature characteristics is a time characteristic.

11. The method according to claim 9, which comprises:
holding the two-component liquid mixture at a temperature near the boiling point; and
cooling the two-component liquid mixture to a predetermined temperature below the boiling point of the two-component liquid mixture.

12. The method according to claim 9, which comprises elevating the temperature of the two-component liquid mixture to a predetermined temperature above the boiling point of the two-component liquid mixture.

13. The method according to claim 11, which comprises setting the predetermined temperature to 15 K.

14. The method according to claim 9, which comprises using an aqueous ortho-phosphoric acid as the two-component liquid mixture.

15. A sensor cell for measuring a concentration of a component in a two-component liquid mixture, comprising:
a body having an interior chamber formed therein;
a sample inlet for feeding the two-component liquid mixture into said chamber;
a sample drain for draining the two-component liquid mixture from said chamber;
a vapor outlet for exhausting an evaporated component from the two-component liquid mixture disposed in said chamber;
an apparatus for setting a temperature of the two-component liquid mixture to below a boiling point of the two-component liquid mixture;
a heating element for elevating the temperature of the two-component liquid mixture to above the boiling point of the two-component liquid mixture, said heating element disposed adjacent said chamber, said apparatus disposed adjacent said heating element; and
a device for calculating a concentration of the component based on an actual temperature of the two-component liquid mixture versus heating element temperature characteristics.
